(19) United States
(12) Patent Application Publication
(10) Pub. No.: US 2025/0175771 A1
(43) Pub. Date: May 29, 2025

(54) APPARATUS AND METHOD FOR BISTATIC/MULTI-STATIC INTEGRATED SENSING AND COMMUNICATION

(71) Applicant: Samsung Electronics Co., Ltd., Gyeonggi-do (KR)

(72) Inventors: Liang HU, San Diego, CA (US); Philippe Jean Marc Michel SARTORI, Naperville, IL (US); Youn Hyoung HEO, Sunnyvale, CA (US)

(21) Appl. No.: 18/962,300

(22) Filed: Nov. 27, 2024

Related U.S. Application Data
(60) Provisional application No. 63/603,862, filed on Nov. 29, 2023.

(51) Int. Cl. H04W 4/38; H04L 5/00; H04W 24/10

(52) U.S. Cl. CPC H04W 4/38; H04L 5/0048; H04L 5/0055; H04W 24/10

(57) ABSTRACT

A system and a method are disclosed for ISAC. A method performed by a sensing initiator includes performing a sensing session setup to exchange sensing capability information with sensing responders for a sensing application; performing a sensing measurement setup with a sensing responder identified in the sensing session setup; and performing sensing measurements with the sensing responder during a sensing burst based on the sensing measurement setup. The sensing burst includes one or more sensing measurement instances. A sensing measurement instance among the one or more sensing measurement instances includes a polling phase, a reporting phase, and at least one of a DL sensing phase or a UL sensing phase.

### CROSS-REFERENCE TO RELATED APPLICATION

This application claims the priority benefit under 35 U.S.C. § 119 (e) of U.S. Provisional Application No. 63/603,862, filed on Nov. 29, 2023, the disclosure of which is incorporated by reference in its entirety as if fully set forth herein.

### TECHNICAL FIELD

The disclosure generally relates to integrated sensing and communication (ISAC). More particularly, the subject matter disclosed herein relates to improvements to system architecture and signal design for ISAC, as well as well as signaling procedures for bistatic and multi-static sensing.

### SUMMARY

ISAC is a technology that integrates sensing and spatial location of passive (not connected) objects into a mobile communication network, expanding the mobile communication network's functionality beyond just communication. Reusing some of the network equipment already deployed for communication can enable an efficient implementation of ISAC. With ISAC, networks can perform sensing, i.e., spatial location (e.g., size, shape, location, velocity, and direction) for different types of objects without being connected to the objects.

A fundamental idea of ISAC is to share mobile communications infrastructure and transform communication networks into sensors for the spatial location of objects that are not necessarily connected to a network. The sensing and communication capabilities in networks can be integrated on multiple levels, including sites, spectrum, radio hardware, waveforms and signals. By combining sensing with the mobile communications infrastructure, network-wide sensing capabilities may be provided.

ISAC's spatial location capabilities are versatile, enabling the identification of an object's size and shape, location, speed and direction. The granularity and accuracy are generally bandwidth dependent, with higher bandwidth providing higher resolutions.

The level of complexity involved in spatially locating an object depends on factors such as the spectrum used, the amount of clutter in the environment, the object's speed, whether the object is airborne or on the ground, the level of accuracy needed, etc.

In view of the foregoing, ISAC is expected to be a key technology component in 6th generation (6G) wireless systems.

However, sensing operations and communication operations traditionally address completely different sets of use cases and requirements. For example, sensing often uses a known signal that is sent in a particular direction and by analyzing the reflected signal various parameters such as channel response, target-presence, and target properties (e.g., position, shape, size, velocity, etc.), can be estimated. In contrast, in communication networks, key performance indicators are often include data-rate, latency and reliability. Accordingly, sensing signal characteristics, such as bandwidth, time duration, periodicity, power, etc., are generally different than those used for communication purposes.

Accordingly, as aspect of the present disclosure is to provide mechanisms for leveraging strengths of wireless sensing technologies with the development of future wireless communication technologies, in order to effectively implement ISAC in future wireless communication systems, such as 5th generation (5G)-Advanced and 6G systems.

Another aspect of the present disclosure is to provide system architecture for ISAC.

Another aspect of the present disclosure is to provide higher layer procedures for bistatic and multi-static sensing in cellular system for FR1 and FR2 carriers.

Another aspect of the present disclosure is to provide signaling messages for use in bistatic and multi-static sensing in a cellular system for both FR1 and FR2 carriers.

In an embodiment, a method performed by a sensing initiator for ISAC is provided. The method includes performing a sensing session setup to exchange sensing capability information with sensing responders for a sensing application; performing a sensing measurement setup with a sensing responder identified in the sensing session setup; and performing sensing measurements with the sensing responder during a sensing burst based on the sensing measurement setup. The sensing burst includes one or more sensing measurement instances. A sensing measurement instance among the one or more sensing measurement instances includes a polling phase, a reporting phase, and at least one of a downlink (DL) sensing phase or an uplink (UL) sensing phase.

In an embodiment, a sensing initiator is provided for ISAC. The sensing initiator includes a communication module; and a processor configured to perform a sensing session setup to exchange sensing capability information with sensing responders for a sensing application, perform a sensing measurement setup with a sensing responder identified in the sensing session setup, and perform sensing measurements with the sensing responder during a sensing burst based on the sensing measurement setup. The sensing burst includes one or more sensing measurement instances. A sensing measurement instance among the one or more sensing measurement instances includes a polling phase, a reporting phase, and at least one of a DL sensing phase or a UL sensing phase

### BRIEF DESCRIPTION OF THE DRAWING

In the following section, the aspects of the subject matter disclosed herein will be described with reference to exemplary embodiments illustrated in the figures, in which:

FIGS. 1A and 1B illustrate examples of monostatic sensing and bistatic sensing, respectively;

FIG. 2 illustrates a system architecture for ISAC, according to an embodiment;

FIG. 3 is a signal flow diagram illustrating a sensing procedure in FR1 or FR2, according to an embodiment;

FIG. 4 illustrates an example of a sensing measurement instance in FR1, according to an embodiment;

FIG. 5 illustrates four different examples of sensing measurement instance in FR1, according to an embodiment;

FIG. 6 illustrates an example of a sensing measurement instance in UL in FR1, according to an embodiment;

FIG. 7 illustrates an example of a sensing measurement instance in DL in FR1, according to an embodiment;

FIG. 8 illustrates an example of a multistatic sensing measurement instance in DL in FR2, according to an embodiment;

FIG. 9 illustrates an example of a sensing burst configuration for Doppler estimation of a target, according to an embodiment;

FIG. 10 illustrates an example of a multistatic sensing measurement instance in UL in FR2, according to an embodiment;

FIG. 11 is a flowchart illustrating a method performed by a sensing initiator, according to an embodiment;

FIG. 12 is a block diagram of an electronic device in a network environment, according to an embodiment; and

FIG. 13 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Generally, monostatic sensing and bistatic sensing are the two most common sensing modalities. In monostatic sensing, a transmitter and a receiver are co-located (or connected with fiber and act as distributed monostatic system), and thus share complete knowledge of the transmitted signals and timing. However, in bistatic sensing, a transmitter and a receiver are usually at different locations from each other, and the receiver may only have partial knowledge of the transmitted signals and a synchronization problem between the transmitter and the receive should be considered. Although monostatic sensing and bistatic sensing can be employed simultaneously, most existing works only consider one of them.

Another type of sensing is multistatic sensing. While both multistatic and bistatic sensing involve spatially separated transmitters and receivers, a key difference is that bistatic sensing uses only one transmitter and one receiver at separate locations, while multistatic sensing utilizes multiple transmitters and receivers distributed across different locations, allowing for a more comprehensive view of a target area. Essentially, multistatic sensing system is composed of multiple bistatic configurations.

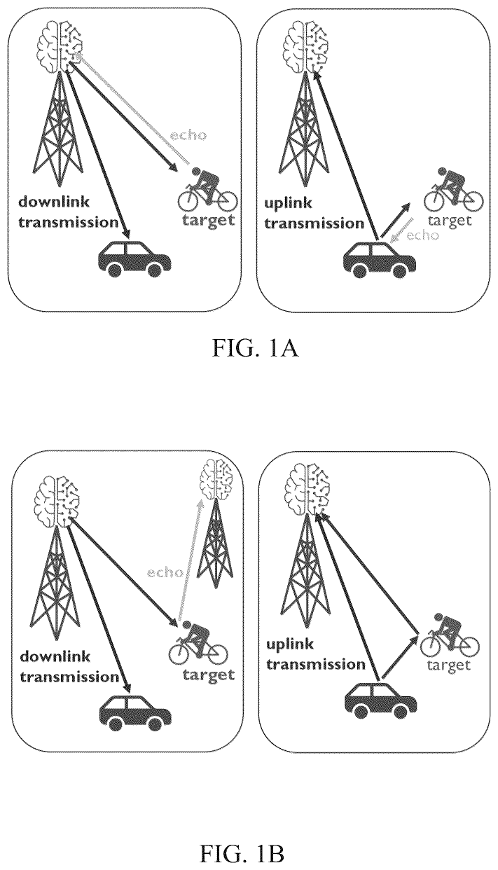

FIGS. 1A and 1B illustrate examples of monostatic sensing and bistatic sensing, respectively.

Referring to FIG. 1A, in the first monostatic sensing example, a transmitter and receiver are both included in a base station. That is, the base station transmits a DL transmission and receives a UL echo signal reflected from a target.

In the second monostatic sensing example, a transmitter and receiver are both included in a car. That is, the car transmits a UL transmission and receives a DL echo signal reflected from a target.

Referring to FIG. 1B, in the first bistatic sensing example, a transmitter is included in a first base station and a receiver is included in a second base station. That is, the first base station transmits a DL transmission and the second base station receives a UL echo signal reflected from a target.

In the second bistatic sensing example, a transmitter is included in a car and a receiver is included in a base station. That is, the car transmits a UL transmission and the base station receives a UL echo signal reflected from a target.

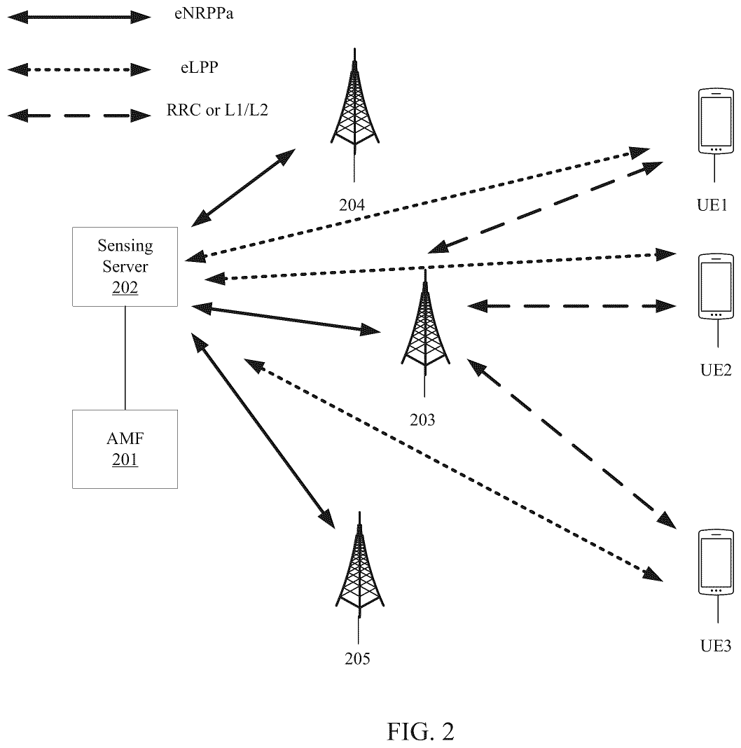

FIG. 2 illustrates a system architecture for ISAC, according to an embodiment.

Referring to FIG. 2, the system includes an access and mobility management function (AMF) 201, a sensing server 202, a serving gNB 203, neighboring gNBs 204 and 205, user equipment 1 (UE1), UE2, and UE3.

The AMF 201 handles control plane functions like registration management, connection management, reachability management, mobility management, and access authentication. The AMF 201 may interact with other core network functions and external entities via service-based interfaces like Namf.

The sensing server 202 includes a sensing management function with an associated sensing protocol similar to or merged with a location management function (LMF) and LTE positioning protocol (LPP)/new radio (NR) positioning protocol (NRPPa) in NR positioning. The sensing server 202 may be included in or provided outside of a 3rd generation partnership project (3GPP) core network. The sensing server 202 may exchange signaling with UE1, UE2, and UE3 via an enhanced LPP (eLPP), which runs over the serving gNB 203. The sensing server 202 may exchange signaling with the serving gNB 103 and neighboring gNBs 204 and 205 via an enhanced NRPPa (eNRPPa), whereas the serving gNB 203 may exchange signaling with UE1, UE2, and UE3 via radio resource control (RRC) or layer 1 (L1)/layer 2 (L2) signaling.

UE1, UE2, and UE3 can measure the sensing signals from the serving gNB 203 and non-serving, neighboring gNBs 204 and 205, similar to NR positioning, where a UE can measure positioning reference signals (PRSs) from the serving gNB 203 and non-serving, neighboring gNBs 204 and 205.

If a sensing signal is transmitted from the serving gNB 203 or the non-serving, neighboring gNBs 204 and 205 in a DL, a sensing report from UE1, UE2, or UE3 can be transmitted to the sensing server 202 via the eLPP. Similarly, UE1, UE2, or UE3 can transmit a sensing signal for UL sensing at the serving gNB 203 and the non-serving, neighboring gNBs 204 and 205, and the gNBs can make sensing measurements of the received signal. A sensing report from the serving gNB 203 and the non-serving, neighboring gNBs 204 and 205 can be transmit to the sensing server 202 via the eNRPPa.

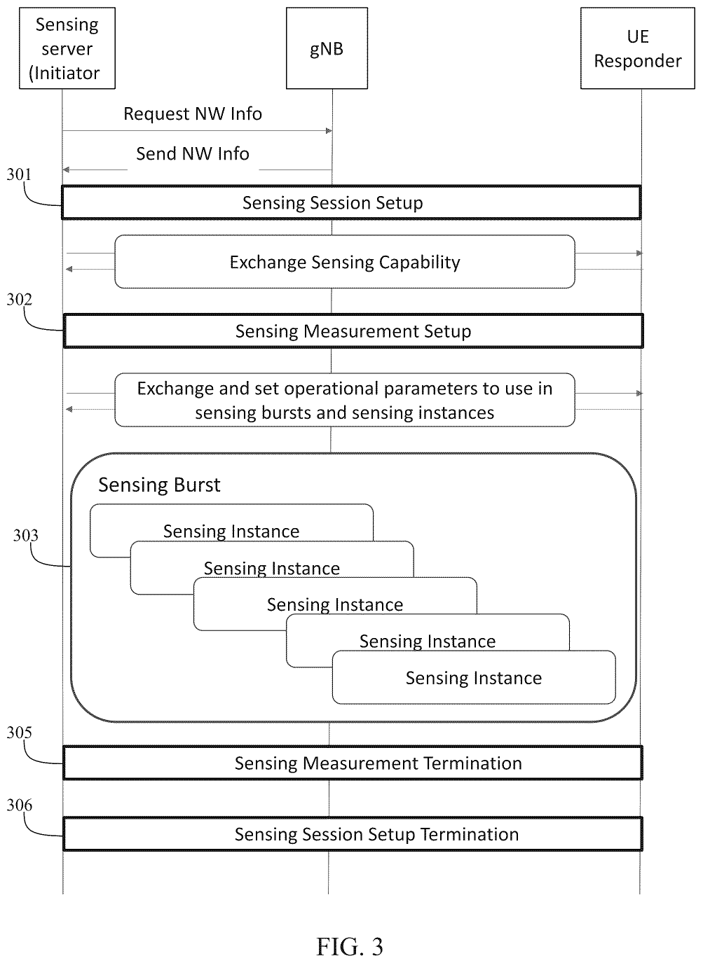

FIG. 3 is a signal flow diagram illustrating a sensing procedure on FR1 or FR2, according to an embodiment.

Referring to FIG. 3, the sensing procedure includes one or more of the following steps:
Step 301—Sensing session setup.
Step 302—Sensing measurement setup.
Step 303—Sensing burst.
Step 304—Sensing instance.
Step 305—Sensing measurement setup termination.
Step 306—Sensing session termination.

More specifically, in step 301, the sensing session setup is an agreement between a sensing initiator and a sensing responder to participate in a sensing procedure. Here, the sensing initiator and sensing responder are defined depending on whether a UE, a gNB, a sensing server, or an AMF initiates a sensing procedure, and requests and/or obtains measurements. Both the sensing initiator and sensing responder can be a gNB, a UE, a sensing server, or an AMF. Essentially, a sensing initiator is a gNB, UE, sensing server, or AMF that initiates a sensing procedure, while a sensing responder is a gNB, UE, sensing server, or AMF that participates in a sensing procedure initiated by a sensing initiator.

In step 302, the sensing measurement setup allows a sensing initiator and a sensing responder to exchange and agree on operational attributes (i.e., special operational information) associated with a sensing measurement instance, which may include the roles of the gNB, UE, sensing server, and AMF, the type of measurement report, and/or other operational parameters.

For a given sensing session (i.e., a given sensing initiator and responder), there can be various sensing sub-modes, such as: 1) a gNB based mode, 2) a UE-based mode 3) a UE-assisted sensing server-based mode, and/or 4) a gNB assisted sensing server-based mode.

Similar to NR positioning, the suffixes “-based” and “-assisted” herein refer respectively to a node that is responsible for making the sensing calculation (and which may also provide measurements) and a node that provides sensing measurements (but which does not make the sensing calculation). Thus, an operation in which measurements are provided by the UE to the sensing server to be used in the computation of a sensing estimate may be described as being “UE-assisted” (and could also be referred as “sensing server-based”), while an operation in which the UE computes its own sensing estimate is described as “UE-based”.

In FIG. 3, before a sensing session setup is performed in step 301, a sensing server sends, via eNRPPa, a request for network (NW) information to a gNB, which is the serving gNB of a UE. The request may be for a list of UEs served by the serving cell and any neighboring cells (included an area to be sensed), which the gNB then sends back to the sensing server. This exchange can be done via eNRPPa between the sensing server and the gNB.

Alternatively, the request can include an indication of “a geographical area to be sensed” and sent by the sensing server to the gNB(s). Thereafter, it is up to the gNB to decide which UEs shall participate in the sensing session, according to the indicated “geographical sensing area”. The indication of a “geographical sensing area” can be defined by a set of gNBs or transmission reception point (TRP) indexes.

In the sensing session setup of step 301, it is likely that not all UEs or gNBs will support sensing or all sensing types and roles. Thus, the sensing session setup allows a sensing initiator, i.e., the sensing server in FIG. 3, and a sensing responder, i.e., the UE in FIG. 3, to exchange sensing capabilities such as the sensing type supported (e.g., bistatic or multistatic), the roles supported for a given sensing type (e.g., a UE, gNB, sensing server, or AMF supports being a sensing receiver for bistatic), or sensing reports type available (e.g., raw channel state information (CSI) measurements or sensing processed results). The capabilities may be exchanged using procedures commonly used in a 3GPP cellular network, such as LPP, between a UE and an LMF.

The sensing session setup in step 301 helps a sensing initiator to identify the potential UEs or gNBs that can be used as a sensing responder for a given sensing application with given requirements. For example, in the case of a gNB assisted mode, communication between the sensing server and the gNB should be based on eNRPPa.

Additionally, multiple sensing sessions can exist simultaneously, where each sensing session can be uniquely identified by a serving gNB identifier and/or a cell (C)-radio network temporary identifier (RNTI) of the UE establishing the sensing session. In addition, multiple sensing sessions can be maintained by the same sensing initiator to meet requirements of the sensing procedure.

The sensing measurement setup of step 302 is used to configure sensing parameters and UE roles for a given sensing application. The sensing measurement setup of step 302 allows the sensing initiator and the sensing responder to exchange and agree on operational parameters (OPs) associated with sensing bursts and sensing instances. The OPs can include the sensing roles of the sensing initiator and the sensing responder(s), the sensing type, the burst configuration, the measurement report types, and other parameters.

The sensing measurement setup of step 302 may include the initiator sending a sensing measurement setup request frame to a responder, which replies with a sensing measurement response frame either accepting, rejecting, or proposing new OPs to the sensing initiator. The sensing initiator may repeat this process for each sensing responder involved in the sensing procedure.

To identify a specific set of operational attributes, measurement setups with different sets of operational attributes may be assigned by different measurement setup identifiers (IDs).

Compared to the sensing session setup in step 301, in sensing measurement setup in step 302, the sensing initiator and responder shall agree on more detailed operational parameters such as a sensing sub-mode (e.g., a gNB based mode, a UE-based mode, a UE-assisted sensing server-based mode, or a gNB assisted sensing server-based mode.

Alternatively, steps 301 and 302 can be combined.

The actual sensing measurements may be organized through sensing bursts in step 303 and sensing instances in step 304.

The sensing burst in step 303 may represent a time dedicated to sensing measurements for a single Doppler processing, i.e., the measurements used to obtain a data cube that can be a (range, doppler) map. Each sensing burst may include one or more sensing instances in step 304, which is the effective period of time where the measurements take place. Each sensing instance in step 304 may include one or more sensing reference signal (RS) transmissions, where the sensing RS used depends on the sensing type.

The sensing burst in step 303 may define two scheduling parameters: 1) an intra-burst interval, and 2) an inter-burst interval.

An intra-burst interval defines a time between two consecutive sensing instances belonging to the same burst, while an inter-burst interval is a time between the two consecutive bursts (i.e., the refresh time between two data cubes, if an application requires more than one Doppler processing).

For example, computation of a Doppler frequency shift may require collection of I measurements every T over a given observation time Tc. In this case, Doppler processing with an intra-burst interval is T, a sensing burst duration is the observation time Tc, and a number of sensing instances in a sensing burst is I.

Each sensing instance in step 304 belongs to a single sensing burst and includes a sounding phase. Each sensing instance may also include an initiation phase and/or a reporting phase. The initiation phase allows a sensing initiator to check if the sensing responders participating in the sensing procedure are available and also to configure information about the sounding (e.g., which sensing responder should perform the sounding first for a coordinated bistatic sensing). The initiation phase includes the sensing initiator sending a sensing request frame to each responder, which in turn replies with a sensing response frame.

During the sounding phase, the sensing measurements are performed using sensing RSs. Different sensing RSs may be used depending on the sensing type.

The measurement instance identifiers IDs may be used to identify different sensing measurement instances.

Accordingly to an embodiment, RRC signaling or dynamic signaling may be used to enable signaling in a sensing instance:

For RRC signaling, a set of new RRC messages may be defined, such as a sensing polling trigger message, a sensing polling response message, a sensing sounding trigger message, a DL sensing announcement message, and a UL sensing report message, as will be described in more detail below.

For dynamic signaling, messages can be based dynamic DL control information (DCI), group DCI, a physical UL control channel (PUCCH)/physical UL shared channel (PUSCH), and/or a MAC control element (CE). In case a PUCCH/PUSCH is employed for a UL sensing report message, legacy CSI report framework can be extended with definitions of new CSI triggering states for aperiodic or semi-persistent sensing reports. A list of new DCI or MAC CE messages will be described in more detail below.

After a sensing session is established, a sensing measurement session may be terminated either explicitly or implicitly.

Under an explicit sensing measurement setup termination in step 305, a UE may request an AMF or sensing server for the sensing measurement setup termination, or the AMF or sensing server itself may use a sensing measurement setup termination frame for sensing measurement setup termination.

Under an implicit sensing measurement setup termination in step 305, the sensing measurement setup may be terminated after the expiration of a sensing procedure timer.

A sensing measurement setup may be explicitly terminated at any time, by either the sensing initiator or the sensing responder, by transmitting an individually addressed sensing measurement termination frame.

In the sensing session termination in step 306, the sensing server and the UE terminate the sensing session established therebetween. If the sensing session between the sensing server and the UE is terminated, all active sensing measurement sessions established between the sensing server and the UE should be terminated. The sensing session between the sensing server and the UE may be terminated when the UE disassociates from the sensing server.

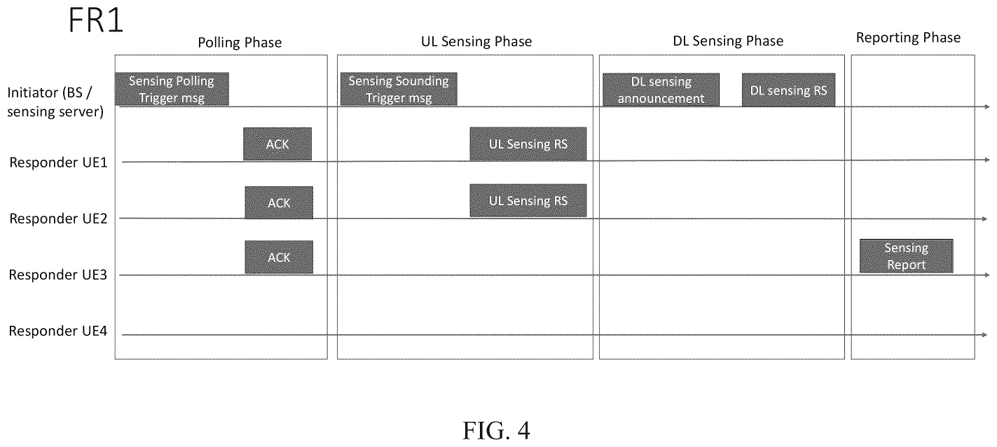

FIG. 4 illustrates an example of a sensing measurement instance in FR1, according to an embodiment. More specifically, FIG. 4, illustrates an example of a sensing measurement instance in FR1 where a sensing mode is bistatic.

Referring to FIG. 4, the sensing measurement instance includes a polling phase, a UL sensing phase, and a DL sensing phase. In FR1, a sensing mode can only be monostatic or bistatic. To effectively measure a channel between a sensing initiator and multiple responders at a given measurement instance, the sensing initiator should first perform polling to identify the responder UEs that are expected to participate in the upcoming sensing sounding in the measurement instance. If a UE is likely to perform the upcoming sensing sounding, it can return a response to request participation in a sensing measurement instance. Basically, polling may be performed to availability of responder UEs before performing actual sensing measurements. After the polling phase, the sensing initiator can then perform sensing measurement with the responders, i.e., the UL and DL sensing phases.

In the example in FIG. 4, during the polling phase, an initiator (e.g., a base station (BS)/sensing server) polls UE1, UE2, UE3, and UE4 via a sensing polling trigger message, which can be implemented by layer L1 DCI, a MAC CE, or an RRC message, where UE1 and UE2 are sensing transmitters, and UE3 and UE4 are sensing receivers.

Depending on the sensing application, UE1, UE2, UE3, and UE4 are determined by a sensing server or by a serving BS.

In the example in FIG. 4, in response to the sensing polling trigger message, UE1, UE2, and UE3 return responses (e.g., acknowledgement (ACK)) to the BS, so both a UL sensing phase and DL sensing phase are present. The response messages of UE1, UE2, and UE3 can be implemented via L1 UL control information (UCI), a MAC CE, or an RRC message.

In the UL sensing phase, the BS sends a sensing sounding trigger message to UE1 and UE2 to solicit UL sensing RS transmissions. The sensing sounding trigger message can be implemented by L1 DCI, a MAC CE, or an RRC message.

In response the sensing sounding trigger message, UE1 and UE2 transmit UL sensing RSs, which are measure by the BS.

In the DL sensing phase, the BS sends a DL sensing announcement message followed by a DL sensing RS to UE3, where the DL sensing announcement message can be implemented by L1 DCI, a MAC CE, or an RRC message.

In a reporting phase, sensing measurement results are reported by UE3. The corresponding sensing measurement reporting can be either immediate or delayed.

During the reporting phase, the transmitter BS may send a trigger message to a receiver UE to request sensing measurement results obtained from the DL measurement instance, when an immediate feedback reporting is provided, or from a previous measurement instance, when a delayed feedback reporting is provided. For delayed reporting, a responder UE can send delayed measurement reports for multiple sensing measurement instances together as a single feedback.

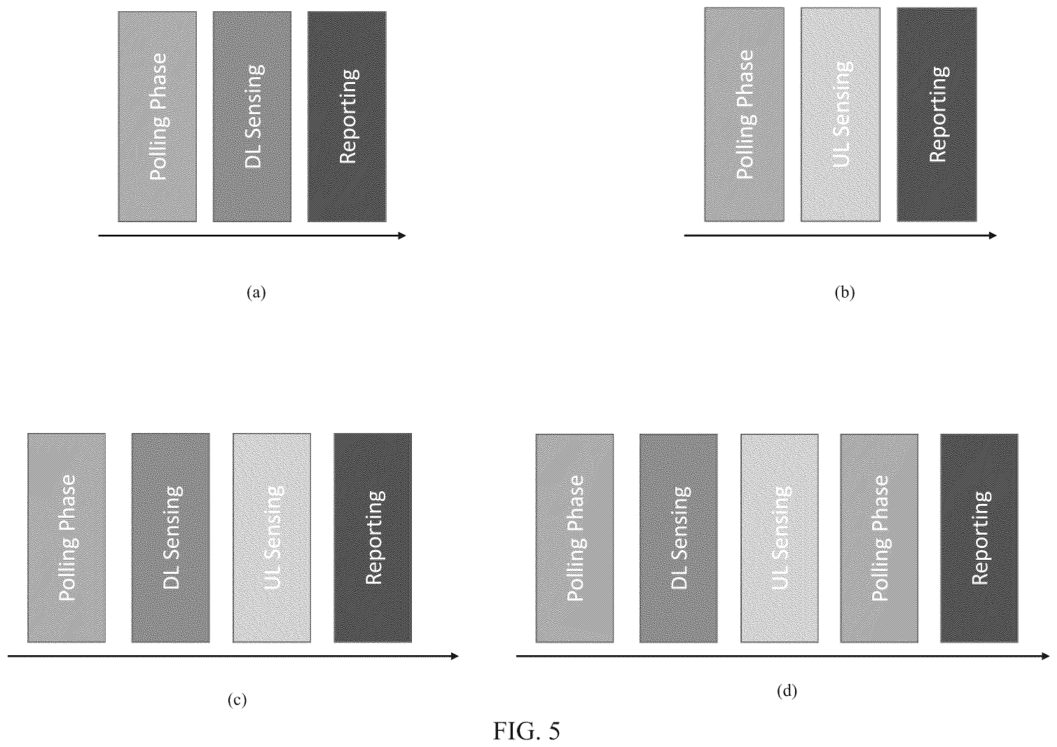

FIG. 5 illustrates four different examples of sensing measurement instance in FR1, according to an embodiment.

Referring to FIG. 5, other possible sensing measurement instances in FR1 may include at least one of a polling phase, a DL sensing phase, a UL sensing phase, or a reporting phase. Any combination in the order of these phases may be present in the sensing measurement instance.

More specifically, in example (a) of FIG. 5, the sensing measurement instance includes a polling phase, a DL sensing phase, and a reporting phase. In example (b) of FIG. 5, the sensing measurement instance includes a polling phase, a UL sensing phase, and a reporting phase. In example (c) of FIG. 5, the sensing measurement instance includes a polling phase, a DL sensing phase, a UL sensing phase, and a reporting phase. In example (d) of FIG. 5, the sensing measurement instance includes a polling phase, a DL sensing phase, a UL sensing phase, another polling phase, and a reporting phase.

To effectively measure a channel between an initiator BS and multiple responder UEs, the initiator BS should first perform polling to identify the responder UEs that are expected to participate in the upcoming sensing in the sensing measurement instance. If UEs are likely to perform upcoming sensing sounding, they can return a response to request participation in a sensing measurement instance. As described above, polling may be performed to check the availability of the responder UE before performing the actual sensing measurement in the sensing measurement instance.

After polling, the initiator BS can perform sensing measurements with the responder UEs. In the DL sensing phase, the initiator BS, which is a sensing transmitter, sends a DL sensing signal to the UEs that are sensing receivers and that have responded in the polling phase to perform DL sensing sounding. In a UL sensing phase, the initiator BS, as a sensing receiver, requests the responder UEs, which are sensing transmitters and responded in the polling phase, to perform UL sensing signal transmission for UL sensing sounding. The DL sensing phase and UL sensing phase are optionally present, if at least one responder UE that is a sensing receiver/transmitter has responded in the polling phase. The last phase of a sensing measurement instance is the reporting phase.

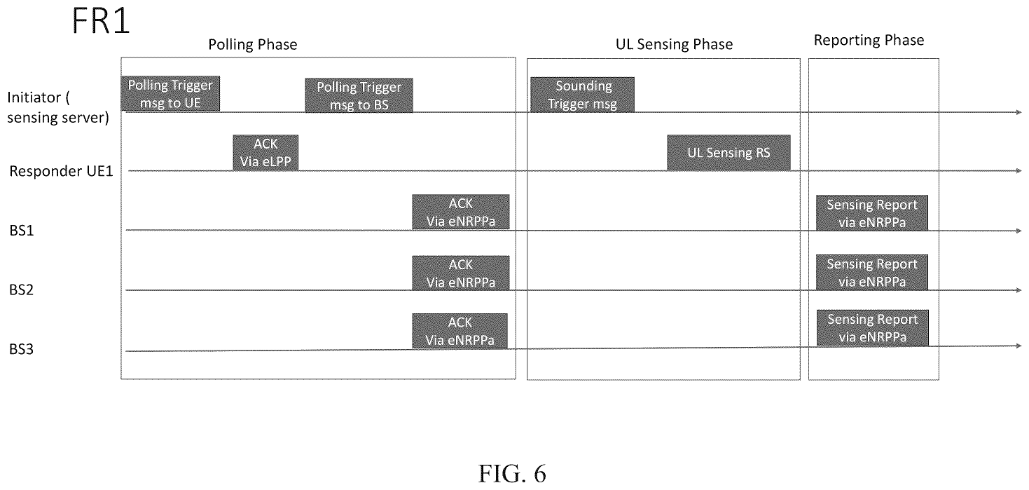

FIG. 6 illustrates an example of a sensing measurement instance in UL in FR1, according to an embodiment. More specifically, FIG. 6 illustrates signaling and messages for a gNB-assisted sensing server-based mode.

Referring to FIG. 6, UL sensing can be performed, where a responder UE1 sends a UL sensing signal and multiple BSs/gNBs (i.e., both a serving gNB and neighboring gNBs) make sensing measurements.

In the example in FIG. 6, in a polling phase, a sensing initiator, which is a sensing server, polls UE1 via a sensing polling trigger message that can be implemented by eLPP. In response, UE1 sends an ACK or NACK to the sensing server, via eLPP, to agree or disagree to being a sensing responder. The sensing initiator also sends a sensing polling trigger message to BS1, BS2, and BS3 via eNRPPa. In the example of FIG. 6, each of BS1, BS2, and BS3 responds, via eNRPPa, to the sensing server with an ACK, confirming to perform UL sensing measurements.

In the UL sensing phase, the sensing server sends a sounding trigger message to responder UE1 via eLPP. UE1 then sends a UL sensing RS to BS1, BS2, and BS3 at the physical layer, via unicast, multicast, or broadcast. In response, BS1, BS2, and BS3 make UL sensing measurements and report the sensing results to sensing server via eNRPPa.

The different types of sensing reports in FR1 may include:
1. Full CSI matrix, i.e., frequency domain channel impulse response per orthogonal frequency-division multiplexing (OFDM) subcarrier.
2. Partial CSI matrix, i.e., amplitude or phase of a CSI matrix.
3. Truncated power delay profile (TPDP)/truncated channel impulse response (TCIR).

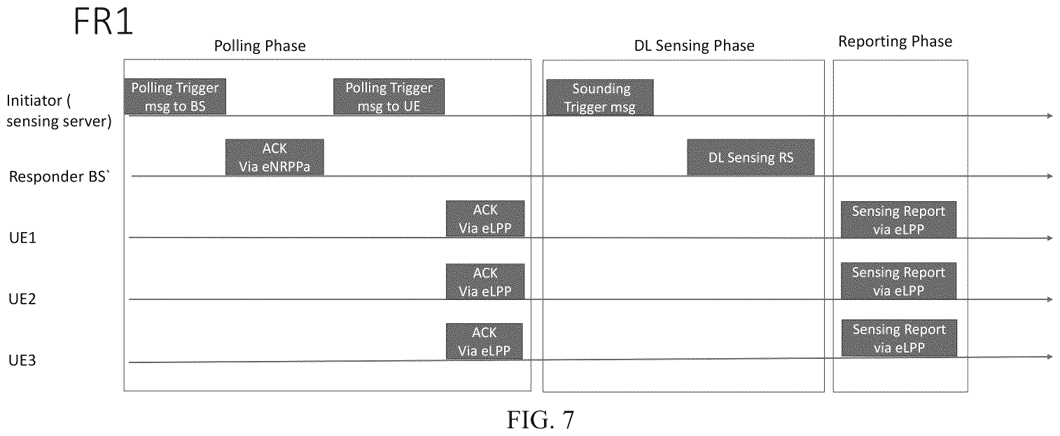

FIG. 7 illustrates an example of a sensing measurement instance in DL in FR1, according to an embodiment. More specifically, FIG. 7 illustrates signaling and messages for a UE-assisted sensing server-based mode.

Referring to FIG. 7, DL sensing can be performed, where a responder BS1 sends a DL sensing RS and multiple UEs make sensing measurements.

In the example in FIG. 7, in a polling phase, a sensing initiator, which is a sensing server, polls BS1 via a sensing polling trigger message that can be implemented by eNRPPa. In response, BS1 sends an ACK or NACK to the sensing server, via eNRPPa, to agree or disagree to being a sensing responder. The sensing initiator also sends a sensing polling trigger message to UE1, UE2, and UE3 via eLPP. In the example of FIG. 7, each of UE1, UE2, and UE3 responds, via eLPP, to the sensing server with an ACK, confirming to perform DL sensing measurements.

In the DL sensing phase, the sensing server sends a sounding trigger message to responder BS1 via eNRPPa. BS1 then sends a DL sensing RS to UE1, UE2, and UE3 at the physical layer, via unicast, multicast, or broadcast. In response, UE1, UE2, and UE3 make DL sensing measurements and report the sensing results to sensing server via eLPP.

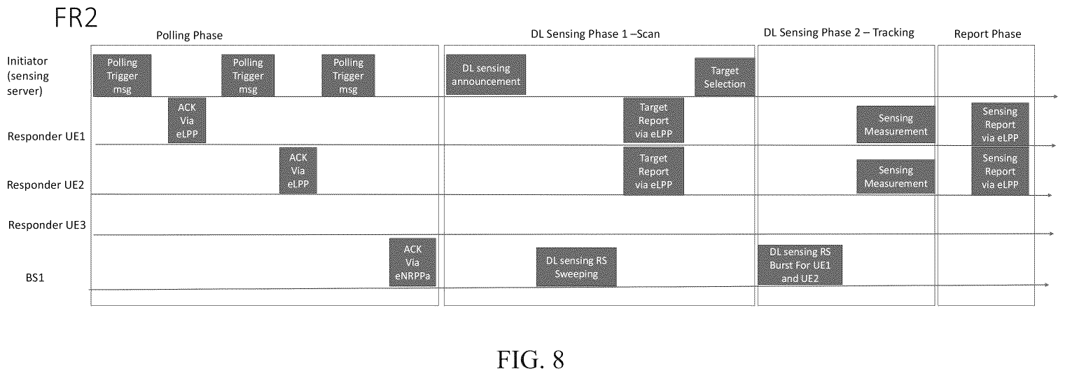

FIG. 8 illustrates an example of a multistatic sensing measurement instance in DL on FR2, according to an embodiment. More specifically, FIG. 8 illustrates signaling and messages for a UE-assisted sensing server-based mode.

Referring to FIG. 8, in a polling phase, a handshake between an initiator sensing server and responder UEs (i.e., UE1 and UE2) activate the responders to be ready to participate in the sensing via eLPP and report in sequence during the reporting phase. In addition, the initiator sensing server also performs a handshake with the BS1 to participate in the DL multistatic sensing, which is a sensing signal transmitter for DL sensing, via eNRPPa.

In FIG. 8, the actual sensing takes place in two phases: a scan phase (DL sensing phase 1-scan) and a tracking phase (DL sensing phase 2-tracking).

After receiving ACK responses from UE1, UE2, and BS1, in the DL sensing phase 1-scan, the initiator sensing server transmits a DL sensing announcement message to UE1, UE2, and BS1. In particular, the DL announcement message may include a sensing signal resource configuration and a measurement report configuration for UE1, UE2, and BS1. The DL announcement message announcement message is sent to UE1 and UE2 via eLPP and to BS1 via eNRPPa.

Thereafter, the serving gNB, i.e., BS1, performs DL sensing beam sweeping in order to detect potential targets at the receiver UEs. UE1 and UE2 perform DL sensing signal measurements at the physical layer and report a list of detected target information (i.e., send a target report) to the sensing server via eLPP. Based on the target reports, the sensing server decides which target(s) are to be tracked by UE1 and UE2 in the tracking phase and informs UE1 and UE2 about this via eLPP.

The sensing server may also configure a corresponding DL sensing signal configuration for object tracking to BS1 via eNRPPa. The detected targets reported at each UE can be identified by BS/TRP ID and/or a DL TX beam ID and/or a DL RX beam ID at each UE.

In DL sensing phase 2-tracking, DL sensing RS bursts for tracking are multicast by BS 1 to UE1 and UE2 at physical layer. UE1 and UE2 make tracking measurements and report the results to the initiator sensing server via eLPP in the report phase.

In the report phase, the sensing initiator sensing server can optionally poll each of UE1 and UE2 for a sensing report, and the sensing responders (UE1 and UE2) respond in a predefined order.

For multicast DL sensing RS burst design, UE1 or UE2 may perform measurement on a subset of DL sensing beams pre-configured by the sensing server for UE1 and UE2, respectively. The pre-configuration per UE may depends on a selected target to be tracked by a respective UE.

Examples of different types of sensing reports in FR2 may include:
1. Full CSI
2. Sensing Image Direction (azimuth and the elevation angles of the target)
3. Sensing Image Range-Doppler
4. Sensing Image Range-Direction
5. Sensing Image Doppler-Direction
6. Sensing Image Range-Doppler Direction
7. Target's parameters (e.g., position and velocity)

To estimate Doppler/velocity of a moving target, a sensing burst including multiple sensing instances in time may be utilized.

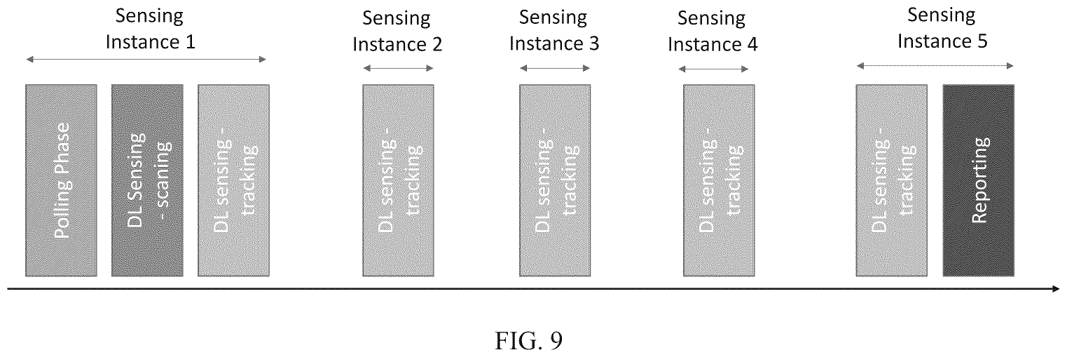

FIG. 9 illustrates an example of a sensing burst configuration for Doppler estimation of a target, according to an embodiment.

Referring to FIG. 9, sensing instances include a subset of phases illustrated in FIG. 8.

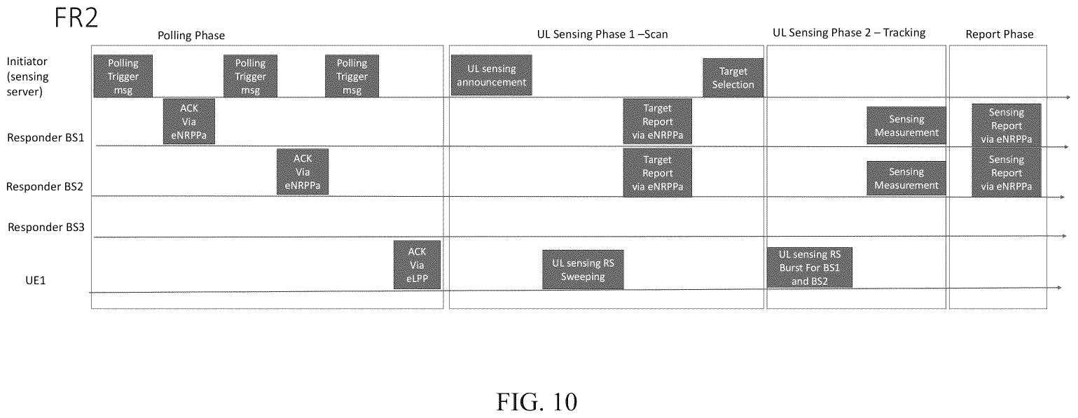

FIG. 10 illustrates an example of a multistatic sensing measurement instance in UL in FR2, according to an embodiment. More specifically, FIG. 10 illustrates signaling and messages for a gNB-assisted sensing server-based mode.

Referring to FIG. 10, in a polling phase, a handshake between an initiator sensing server and responder BSs (i.e., BS1 and BS2) activate the responders to be ready to participate in the sensing via eNRPPa and report in sequence during the reporting phase. In addition, the initiator sensing server also performs a handshake with the UE1 to participate in the UL multistatic sensing, which is a sensing signal transmitter for UL sensing, via eLPP.

In FIG. 10, the actual sensing takes place in two phases: a scan phase (UL sensing phase 1-scan) and a tracking phase (UL sensing phase 2-tracking).

After receiving ACK responses from BS1, BS2, and UE1, in the UL sensing phase 1-scan, the initiator sensing server transmits a UL sensing announcement message to BS1, BS2, and UE1. In particular, the UL announcement message may include a sensing signal resource configuration and a measurement report configuration for BS1, BS2, and UE1. The UL announcement message announcement message is sent to BS1 and BS2 via eNRPPa and to UE1 via eLPP.

Thereafter, UE1 performs UL sensing beam sweeping in order to detect potential targets at the receiver BSs. BS1 and BS2 perform UL sensing signal measurements at the physical layer and report a list of detected target information (i.e., send a target report) to the sensing server via eNRPPa. Based on the target reports, the sensing server decides which target(s) are to be tracked by BS1 and BS2 in the tracking phase and informs BS1 and BS2 about this via eNRPPa.

The sensing server may also configure a corresponding UL sensing signal configuration for object tracking to UE1 via eLPP. The detected targets reported at each BS can be identified by UE/TRP ID and/or a UL TX beam ID and/or a UL RX beam ID at each BS.

In UL sensing phase 2-tracking, UL sensing RS bursts for tracking are multicast by UE1 to BS1 and BS2 at physical layer. BS1 and BS2 make tracking measurements and report the results to the initiator sensing server via eNRPPa in the report phase.

In the report phase, the sensing initiator sensing server can optionally poll each of BS1 and BS2 for a sensing report, and the sensing responders (BS1 and BS2) respond in a predefined order.

For multicast UL sensing RS burst design, BS1 or BS2 may perform measurement on a subset of UL sensing beams pre-configured by the sensing server for BS1 and BS2, respectively. The pre-configuration per BS may depends on a selected target to be tracked by a respective BS.

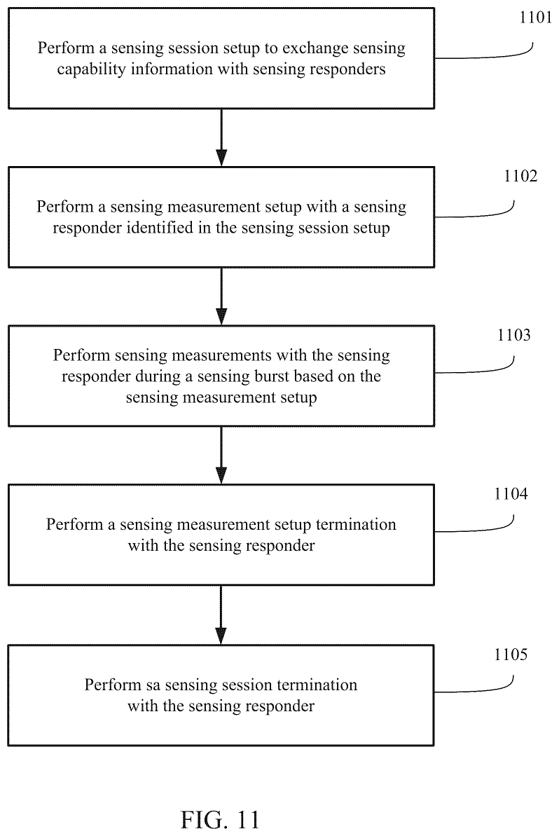

FIG. 11 is a flowchart illustrating a method performed by a sensing initiator, according to an embodiment.

Referring to FIG. 11, in step 1101, the sensing initiator, e.g., a sensing server, a user equipment (UE), or a base station, performs a sensing session setup to exchange sensing capability information with sensing responders, e.g., a sensing server, a UE, or a base station, for a sensing application.

In step 1102, the sensing initiator performs a sensing measurement setup with a sensing responder identified in the sensing session setup.

In step 1103, the sensing initiator performs sensing measurements with the sensing responder during a sensing burst based on the sensing measurement setup. As illustrated in FIG. 3, for example, the sensing burst may include multiple sensing instances.

In step 1104, the sensing initiator performs a sensing measurement setup termination with the sensing responder.

In step 1105, the sensing initiator performs a sensing session termination with the sensing responder.

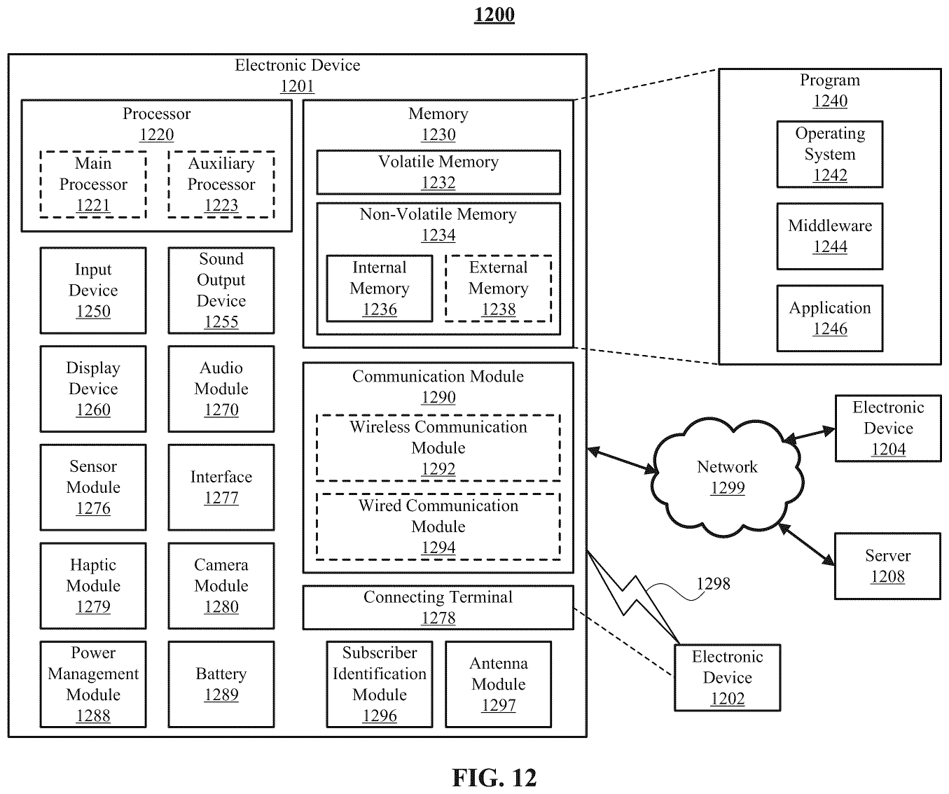

FIG. 12 is a block diagram of an electronic device in a network environment 1200, according to an embodiment.

Referring to FIG. 12, an electronic device 1201 in a network environment 1200 may communicate with an electronic device 1202 via a first network 1298 (e.g., a short-range wireless communication network), or an electronic device 1204 or a server 1208, e.g., a sensing server as described in FIG. 3, via a second network 1299 (e.g., a long-range wireless communication network). The electronic device 1201 may communicate with the electronic device 1204 via the server 1208. The electronic device 1201 may include a processor 1220, a memory 1230, an input device 1250, a sound output device 1255, a display device 1260, an audio module 1270, a sensor module 1276, an interface 1277, a haptic module 1279, a camera module 1280, a power management module 1288, a battery 1289, a communication module 1290, a subscriber identification module (SIM) card 1296, or an antenna module 1297. In one embodiment, at least one (e.g., the display device 1260 or the camera module 1280) of the components may be omitted from the electronic device 1201, or one or more other components may be added to the electronic device 1201. Some of the components may be implemented as a single integrated circuit (IC). For example, the sensor module 1276 (e.g., a fingerprint sensor, an iris sensor, or an illuminance sensor) may be embedded in the display device 1260 (e.g., a display).

The processor 1220 may execute software (e.g., a program 1240) to control at least one other component (e.g., a hardware or a software component) of the electronic device 1201 coupled with the processor 1220 and may perform various data processing or computations, e.g., as illustrated in FIG. 3.

As at least part of the data processing or computations, the processor 1220 may load a command or data received from another component (e.g., the sensor module 1276 or the communication module 1290) in volatile memory 1232, process the command or the data stored in the volatile memory 1232, and store resulting data in non-volatile memory 1234. The processor 1220 may include a main processor 1221 (e.g., a central processing unit (CPU) or an application processor (AP)), and an auxiliary processor 1223 (e.g., a graphics processing unit (GPU), an image signal processor (ISP), a sensor hub processor, or a communication processor (CP)) that is operable independently from, or in conjunction with, the main processor 1221. Additionally or alternatively, the auxiliary processor 1223 may be adapted to consume less power than the main processor 1221, or execute a particular function. The auxiliary processor 1223 may be implemented as being separate from, or a part of, the main processor 1221.

The auxiliary processor 1223 may control at least some of the functions or states related to at least one component (e.g., the display device 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). The auxiliary processor 1223 (e.g., an image signal processor or a communication processor) may be implemented as part of another component (e.g., the camera module 1280 or the communication module 1290) functionally related to the auxiliary processor 1223.

The memory 1230 may store various data used by at least one component (e.g., the processor 1220 or the sensor module 1276) of the electronic device 1201. The various data may include, for example, software (e.g., the program 1240) and input data or output data for a command related thereto. The memory 1230 may include the volatile memory 1232 or the non-volatile memory 1234. Non-volatile memory 1234 may include internal memory 1236 and/or external memory 1238.

The program 1240 may be stored in the memory 1230 as software, and may include, for example, an operating system (OS) 1242, middleware 1244, or an application 1246.

The input device 1250 may receive a command or data to be used by another component (e.g., the processor 1220) of the electronic device 1201, from the outside (e.g., a user) of the electronic device 1201. The input device 1250 may include, for example, a microphone, a mouse, or a keyboard.

The sound output device 1255 may output sound signals to the outside of the electronic device 1201. The sound output device 1255 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1260 may visually provide information to the outside (e.g., a user) of the electronic device 1201. The display device 1260 may include, for example, a display, a hologram device, or a projector and control circuitry to control a corresponding one of the display, hologram device, and projector. The display device 1260 may include touch circuitry adapted to detect a touch, or sensor circuitry (e.g., a pressure sensor) adapted to measure the intensity of force incurred by the touch.

The audio module 1270 may convert a sound into an electrical signal and vice versa. The audio module 1270 may obtain the sound via the input device 1250 or output the sound via the sound output device 1255 or a headphone of an external electronic device 1202 directly (e.g., wired) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. The sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device 1202 directly (e.g., wired) or wirelessly. The interface 1277 may include, for example, a high-definition multimedia interface (HDMI), a universal serial bus (USB) interface, a secure digital (SD) card interface, or an audio interface.

A connecting terminal 1278 may include a connector via which the electronic device 1201 may be physically connected with the external electronic device 1202. The connecting terminal 1278 may include, for example, an HDMI connector, a USB connector, an SD card connector, or an audio connector (e.g., a headphone connector).

The haptic module 1279 may convert an electrical signal into a mechanical stimulus (e.g., a vibration or a movement) or an electrical stimulus which may be recognized by a user via tactile sensation or kinesthetic sensation. The haptic module 1279 may include, for example, a motor, a piezoelectric element, or an electrical stimulator.

The camera module 1280 may capture a still image or moving images. The camera module 1280 may include one or more lenses, image sensors, image signal processors, or flashes. The power management module 1288 may manage power supplied to the electronic device 1201. The power management module 1288 may be implemented as at least part of, for example, a power management integrated circuit (PMIC).

The battery 1289 may supply power to at least one component of the electronic device 1201. The battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more communication processors that are operable independently from the processor 1220 (e.g., the AP) and supports a direct (e.g., wired) communication or a wireless communication. The communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as BLUETOOTH™, wireless-fidelity (Wi-Fi) direct, or a standard of the Infrared Data Association (IrDA)) or the second network 1299 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1292 may identify and authenticate the electronic device 1201 in a communication network, such as the first network 1298 or the second network 1299, using subscriber information (e.g., international mobile subscriber identity (IMSI)) stored in the subscriber identification module 1296.

The antenna module 1297 may transmit or receive a signal or power to or from the outside (e.g., the external electronic device) of the electronic device 1201. The antenna module 1297 may include one or more antennas, and, therefrom, at least one antenna appropriate for a communication scheme used in the communication network, such as the first network 1298 or the second network 1299, may be selected, for example, by the communication module 1290 (e.g., the wireless communication module 1292). The signal or the power may then be transmitted or received between the communication module 1290 and the external electronic device via the selected at least one antenna.

Commands or data may be transmitted or received between the electronic device 1201 and the external electronic device 1204 via the server 1208 coupled with the second network 1299. Each of the electronic devices 1202 and 1204 may be a device of a same type as, or a different type, from the electronic device 1201. All or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1201. The electronic device 1201 may provide the outcome, with or without further processing of the outcome, as at least part of a reply to the request. To that end, a cloud computing, distributed computing, or client-server computing technology may be used, for example.

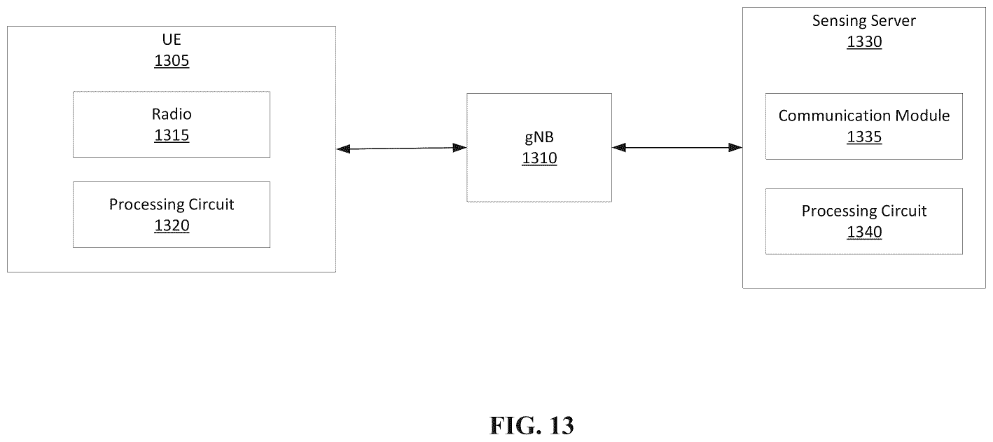

FIG. 13 shows a system including a UE 1305, a gNB 1310, and a sensing server 1330, in communication with each other. The UE 1305 may include a radio 1315 and a processing circuit (or a means for processing) 1320, which may perform various methods disclosed herein, e.g., the method illustrated in FIG. 3. For example, the processing circuit 1320 may receive, via the radio 1315, transmissions from the network node (gNB) 1310, and the processing circuit 1320 may transmit, via the radio 1315, signals to the gNB 1310. The processing circuit 1320 may also receive, via the radio 1315, messages and signals, e.g., as illustrated in FIG. 3, from the sensing server 1330, via the network node (gNB) 1310, and the processing circuit 1320 may transmit, via the radio 1315, signals to the sensing server 1330, via the gNB 1310.

The sensing server 1330 may include a communication module 1335 and a processing circuit (or a means for processing) 1340, which may perform various methods disclosed herein e.g., the method illustrated in FIG. 3. For example, the processing circuit 1340 may receive, via the communication module 1335, transmissions from the network node (gNB) 1310, and the processing circuit 1320 may transmit, via the communication module 1335, signals to the gNB 1310. The processing circuit 1340 may also receive, via the communication module 1335, messages and signals, e.g., as illustrated in FIG. 3, from the UE 1305, via the network node (gNB) 1310, and the processing circuit 1340 may transmit, via the communication module 1335, signals to the UE 1305, via the gNB 1310.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of performed by a sensing initiator for integrated sensing and communication, the method comprising:
performing a sensing session setup to exchange sensing capability information with sensing responders for a sensing application;
performing a sensing measurement setup with a sensing responder identified in the sensing session setup; and
performing sensing measurements with the sensing responder during a sensing burst based on the sensing measurement setup,
wherein the sensing burst includes one or more sensing measurement instances, and
wherein a sensing measurement instance among the one or more sensing measurement instances includes a polling phase, a reporting phase, and at least one of a downlink (DL) sensing phase or an uplink (UL) sensing phase.

2. The method of claim 1, wherein performing the sensing measurement setup with the sensing responder comprises:
sending, to the responder, a sensing measurement setup request frame including operational parameters for performing the sensing measurements; and
receiving, from the responder, a sensing measurement response frame.

3. The method of claim 2, wherein the sensing measurement response frame accepts the operational parameters, rejects the operational parameters, or proposes new operational parameters to the sensing initiator.

4. The method of claim 2, wherein the operational parameters include at least one of a sensing role of the sensing initiator, a sensing role of the sensing responder, a sensing type, a sensing burst configuration, or a measurement report type, and
wherein the sensing role includes at least one of a first role of making a sensing calculation or a second role of providing the sensing measurements.

5. The method of claim 1, wherein the capability information includes at least one of an indication of a supported sensing type, roles supported for a given sensing type, or available sensing report types.

6. The method of claim 1, wherein the sensing initiator includes a sensing server, a user equipment (UE), or a base station, and
wherein the sensing responder includes a sensing server, a UE, or a base station.

7. The method of claim 1, wherein the sensing responder includes a user equipment (UE) and the sensing initiator includes a base station, and
wherein performing the sensing measurements comprises:
transmitting, during the polling phase, a polling trigger message to the UE and one more additional UEs;
receiving an acknowledgement signal from the UE, in response to the polling trigger message; and
receiving an acknowledgement signal from each of the one more UEs, in response to the polling trigger message.

8. The method of claim 7, wherein performing the sensing measurements further comprises:
transmitting, during the UL sensing phase, a sensing sounding trigger message to the UE;
receiving, from the UE, a UL sensing reference signal (RS), in response to the sensing sounding trigger message; and
measuring the received UL sensing RS.

9. The method of claim 7, wherein performing the sensing measurements further comprises:
transmitting, during the DL sensing phase, a DL sensing announcement to the UE; and
transmitting, during the DL sensing phase, a DL sensing reference signal (RS) to the UE.

10. The method of claim 9, wherein performing the sensing measurements further comprises receiving, from the UE, during the reporting phase, a sensing report based on UE measurements of the DL sensing reference signal RS.

11. The method of claim 6, wherein the sensing responder includes a user equipment (UE) and the sensing initiator includes a sensing server, and
wherein performing the sensing measurements comprises:
transmitting, during the polling phase, a polling trigger message to the UE and one more base stations;
receiving an acknowledgement signal from the UE, in response to the polling trigger message; and
receiving an acknowledgement signal from each of the one more base stations, in response to the polling trigger message.

12. The method of the claim 11, wherein the acknowledgement signal from the UE is transmitted via an enhanced LTE positioning protocol, and
wherein the acknowledgement signal from each of the one more base stations is transmitted via an enhanced new radio positioning protocol.

13. The method of claim 11, wherein performing the sensing measurements further comprises transmitting, to the UE, during the UL sensing phase, a sensing sounding trigger message instructing the UE to transmit a UL sensing reference signal (RS).

14. The method of claim 13, wherein performing the sensing measurements further comprises receiving, from each of the one more base stations, during the reporting phase, a sensing report based on measurements of the UL sensing RS.

15. The method of claim 6, wherein the sensing responder includes a base station and the sensing initiator includes a sensing server, and
wherein performing the sensing measurements comprises:
transmitting, during the polling phase, a polling trigger message to the base station and one more user equipments (UEs);
receiving an acknowledgement signal from the BS, in response to the polling trigger message; and
receiving an acknowledgement signal from each of the one more UEs, in response to the polling trigger message.

16. The method of claim 15, wherein performing the sensing measurements further comprises transmitting, to the base station, during the DL sensing phase, a sensing sounding trigger message instructing the base station to transmit a DL sensing reference signal (RS).

17. The method of claim 16, wherein performing the sensing measurements further comprises receiving, from each of the one more UEs, during the reporting phase, a sensing report based on measurements of the DL sensing RS.

18. The method of claim 1, further comprising performing a sensing measurement setup termination with the sensing responder.

19. The method of claim 1, further comprising performing a sensing session termination with the sensing responder.

20. A sensing initiator for integrated sensing and communication, the sensing initiator comprising:
a communication module; and
a processor configured to:
perform a sensing session setup to exchange sensing capability information with sensing responders for a sensing application,
perform a sensing measurement setup with a sensing responder identified in the sensing session setup, and
perform sensing measurements with the sensing responder during a sensing burst based on the sensing measurement setup,
wherein the sensing burst includes one or more sensing measurement instances, and
wherein a sensing measurement instance among the one or more sensing measurement instances includes a polling phase, a reporting phase, and at least one of a downlink (DL) sensing phase or an uplink (UL) sensing phase.
